(19) United States
(12) Patent Application Publication
(10) Pub. No.: US 2011/0089138 A1
(43) Pub. Date: Apr. 21, 2011

(54) METHOD OF MANUFACTURING PRINTED CIRCUIT BOARD

(76) Inventors: Young Gwan Ko, Gyunggi-do (KR); Ryoichi Watanabe, Gyunggi-do (KR); Sang Soo Lee, Seoul (KR); Hee Bum Shin, Seoul (KR); Se Won Park, Seoul (KR); Chil Woo Kwon, Gyunggi-do (KR)

(21) Appl. No.: 12/634,649

(22) Filed: Dec. 9, 2009

(30) Foreign Application Priority Data
Oct. 20, 2009 (KR) 10-2009-0099867

(51) Int. Cl. B44C 1/22

(52) U.S. Cl. 216/17

(57) ABSTRACT

Disclosed is a method of manufacturing a printed circuit board, including (A) forming a first circuit layer on a base substrate and forming a first insulating layer thereon, (B) forming trenches including dummy trenches and wiring trenches on the first insulating layer and plating the trenches, thus providing a trench circuit layer including a dummy circuit pattern and a wiring circuit pattern, (C) removing the dummy circuit pattern of the trench circuit layer, and (D) forming a second insulating layer on the trench circuit layer from which the dummy circuit pattern was removed. The method reduces deviation of plating thickness and thus realizes the design density of a trench circuit layer.

### CROSS REFERENCE TO RELATED APPLICATION

This application claims the benefit of Korean Patent Application No. 10-2009-0099867, filed Oct. 20, 2009, entitled “A method of manufacturing a printed circuit board”, which is hereby incorporated by reference in its entirety into this application.

### BACKGROUND OF THE INVENTION

1. Technical Field

The present invention relates to a method of manufacturing a printed circuit board.

2. Description of the Related Art

Recently, in order to cope with an increase both in signal transmission speed and density of semiconductor chips, the demand for techniques for directly mounting a semiconductor chip on a PCB is increasing. Thus, the development of a PCB having high density and high reliability capable of coping with the increase in the density of the semiconductor chip is required.

The requirements for the PCB having high density and high reliability are closely related to the specs of the semiconductor chip, and may include for example circuit fineness, high electrical properties, high signal transmission structure, high reliability, high functionality and so on. Hence, there is a need for techniques for fabricating the PCB having a fine circuit pattern and micro via-holes in accordance with such requirements.

Typically, examples of a method of forming the circuit pattern of the PCB may include a subtractive process, a full additive process, and a semi-additive process. Among them, a semi-additive process enabling the fineness of the circuit pattern is currently receiving attention.

However, a circuit pattern, which is formed through the semi-additive process, is constructed to protrude from an insulating layer, thus causing a problem in that the circuit pattern is apt to become separated from the insulating layer. In particular, as the circuit pattern becomes increasingly miniaturized, a contact area between the insulating layer and the circuit pattern is reduced, with the result that adhesive force therebetween is correspondingly reduced, thus making the separation of the circuit pattern serious.

Accordingly, a solution to the above limit is to form trench circuit patterns on an insulating layer in such a manner that the trench circuit patterns are engraved in the to insulating layer.

FIGS. 1 to 4 are cross-sectional views and plan views showing a conventional process of manufacturing a printed circuit board 10. With reference to these drawings, the conventional method of manufacturing the printed circuit board 10 is described below.

As shown in FIG. 1, a first circuit layer 12 is formed on a base substrate 11, and then a first insulating layer 13 is deposited on the base substrate 11 and the first insulating layer 13.

As shown in FIG. 2, trenches 14a are formed in the first insulating layer 13.

Subsequently, as shown in FIGS. 3A and 3B, the trenches are plated so as to provide a trench circuit layer 14b.

As shown in FIG. 4, a second insulating layer 15 is deposited on the first insulating layer 13 including the trench circuit layer 14b therein.

As a result, a desired printed circuit board 10 is prepared by the above-described process.

In the conventional printed circuit board 10, when a design density of the trench circuit layer 14b is locally uneven, the plated layer has drastically uneven current density, thus causing significant unevenness in plating thickness of the trench circuit layer 14b which is hard to overcome. More specifically, when a dense region in which the trench circuit layer 14b is concentrated and a sparse region in which the trench circuit layer 14b is sparsely formed are mixed, a plating thickness of the trench circuit layer 14b is inevitably uneven.

### SUMMARY OF THE INVENTION

Accordingly, the present invention has been made keeping in mind the problems encountered in the related art and the present invention is intended to provide a method of manufacturing a printed circuit board, which is capable of preventing unevenness of plating thickness of a trench circuit layer even if there is an error in a design density of the trench circuit layer.

In an aspect, the present invention provides a method of manufacturing a printed circuit board, including: (A) forming a first circuit layer on a base substrate and forming a first insulating layer thereon; (B) forming trenches including dummy trenches and wiring trenches on the first insulating layer and plating the trenches, thus providing a trench circuit layer including a dummy circuit pattern and a wiring circuit pattern; (C) removing the dummy circuit pattern of the trench circuit layer; and (D) forming a second insulating layer on the trench circuit layer with the dummy circuit pattern having been removed therefrom.

In the method, (B) forming and plating the trenches may include (B1) forming the trenches including the dummy trenches and the wiring trenches on the first insulating layer; (B2) forming a plating layer in the trenches; and (B3) polishing an excessive plating layer of the plating layer, thus providing the trench circuit layer including the dummy circuit pattern and the wiring circuit pattern.

In (B) forming and plating the trenches, the trenches may be formed through a laser process or an imprint process.

In the method, (C) removing the dummy circuit pattern may include: (C1) forming etching resist on the trench circuit layer such that the dummy circuit pattern of the trench circuit layer is exposed through the etching resist; (C2) applying an etching solution on the first insulating layer to etch and thus remove the dummy circuit pattern; and (C3) removing the etching resist.

In (D) forming a second insulating layer, the dummy trenches from which the dummy circuit pattern was removed may be filled with the second insulating layer.

In the method, the dummy circuit pattern may be not electrically connected to the wiring circuit pattern.

In the method, the first circuit layer may be electrically connected to the wiring circuit pattern of the trench circuit layer by a via.

The method may further include (E) forming a build-up layer composed of a build-up circuit layer and a build-up insulating layer on the second insulating layer.

### BRIEF DESCRIPTION OF THE DRAWINGS

The features and advantages of the present invention will be more clearly understood from the following detailed description taken in conjunction with the accompanying drawings, in which:

FIGS. 1 to 4 are views showing a conventional process of manufacturing a printed circuit board; and

FIGS. 5 to 12 are views showing a process of manufacturing a printed circuit board, according to the present invention.

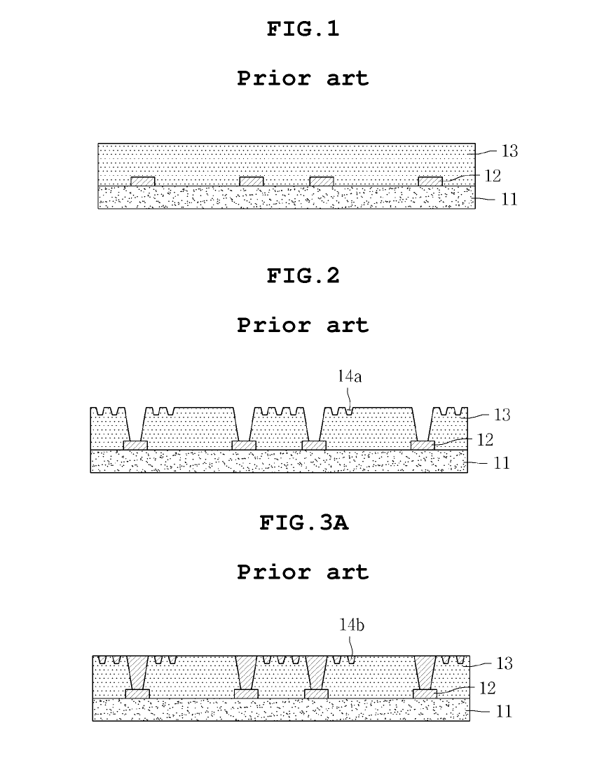

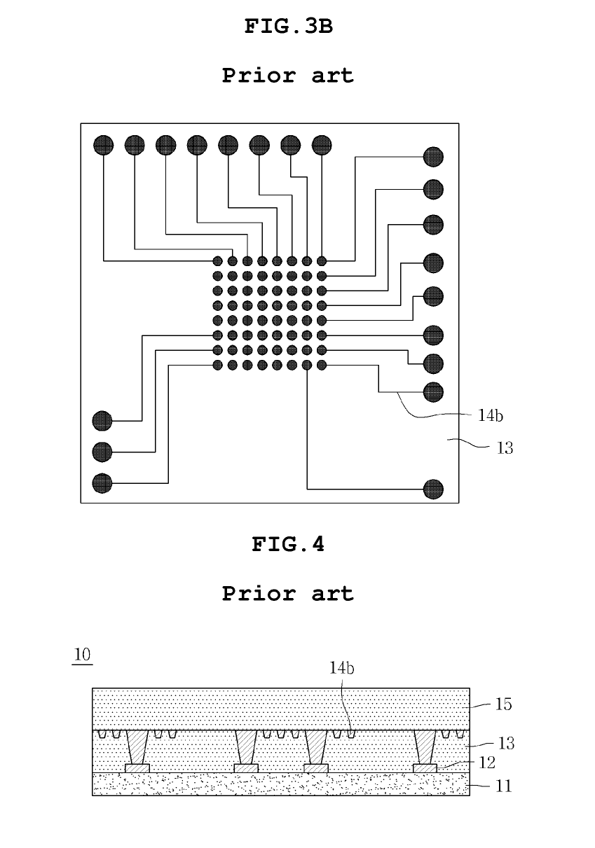

### DESCRIPTION OF SPECIFIC EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to best describe the method he or she knows for carrying out the invention.

It should also be noted that the same reference numerals are used throughout the different drawings to designate the same or similar components. In the following detailed description, it should be noted that the terms “first”, “second” and the like, which are used to indicate various components, are not intended to limit the constituent elements but are intended to differentiate the constituent elements. Also, in the description of the present invention, when it is considered that the detailed description of related art may obscure the gist of the present invention, such a detailed description may be omitted.

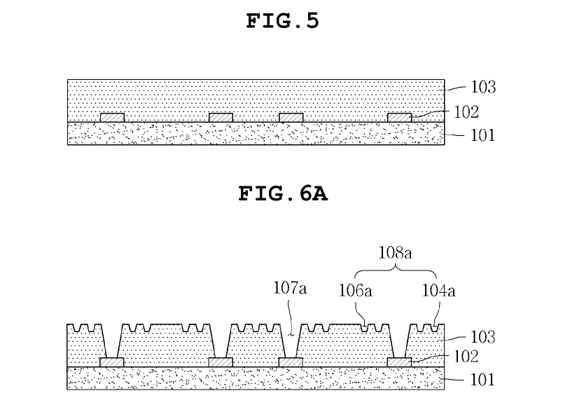

FIGS. 5 to 12 are cross-sectional views and plan views showing a method of manufacturing a printed circuit board 100, according to an embodiment of the present invention. With reference to these drawings, the method of manufacturing a printed circuit board 100, according to an embodiment of the present invention is described below.

As shown in FIG. 5, a first circuit layer 102 is formed on a base substrate 101, and then a first insulating layer 103 is deposited on the first circuit layer 102 and the base substrate 101.

In this regard, the base substrate 101 is made of a rigid material, such as a metal plate or an insulating material, which can provide support for the printed circuit board 100 that is built up later. For example, the metal plate may be embodied as a thin copper plate, and the insulating material may be embodied as complex polymer resin. Alternatively, the base substrate 101 may be embodied as ABF (Ajinomoto Build up Film) to facilitate the easy realization of a fine circuit, or the base plate 101 may be embodied as a prepreg to prepare a thin printed circuit board. The base substrate 101 is not restricted to the above-mentioned materials, but can be made of various rigid materials such as epoxy resin or modified epoxy resin, bisphenol A resin, epoxy-novolac resin, or aramid, glass fiber or paper reinforced epoxy resin.

The first circuit layer 102 may be formed by SAP (Semi-additive Process), MSAP (Modified Semi-additive process) or a Subtractive process, which are usually used in the art. Consequently, the first circuit layer 102 has an embossed profile such that it protrudes from the base substrate 101. A constituent material of the first circuit layer 102 may include an electroconductive metal such as gold, silver, copper, nickel and the like.

The first insulating layer 103 is deposited on the base substrate 101 in such a manner that the base substrate 101 is impregnated with the first insulating layer 103. The first insulating layer 103 may be composed of the same insulating material as that of the base substrate 101.

In this embodiment, although the base substrate 101 has been described as having the circuit layer and the insulating layer only on one side of thereof, the configuration is merely provided for illustrative purposes, and the circuit layer and the insulating layer may also be formed on both sides thereof.

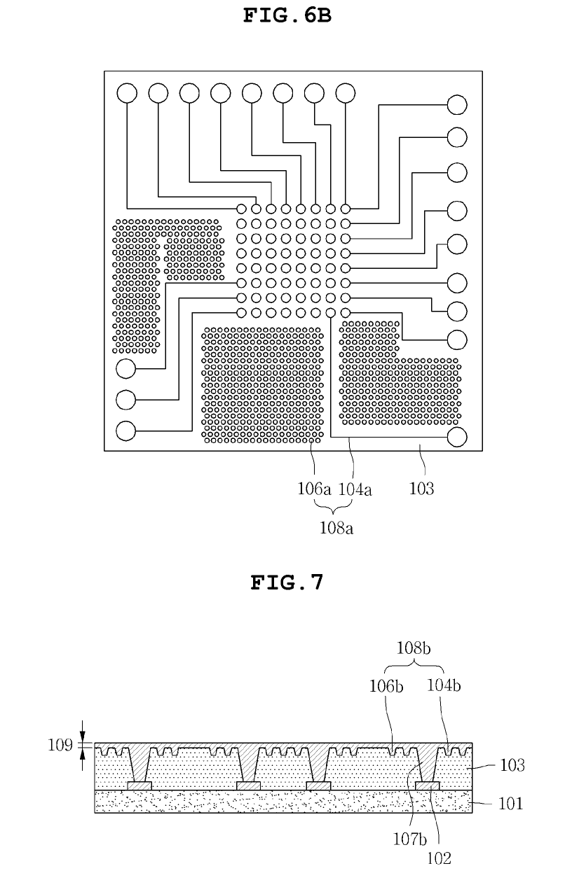

Subsequently, as shown in FIGS. 6A and 6B, the first insulating layer 103 is formed with trenches 108a including wiring trenches 104 and dummy trenches 106a.

At this point, the trenches 108a may be formed in such a manner that the first insulating layer 103 is partially removed in a thickness direction in consideration of a size and thickness of the trench circuit layer 108b. Furthermore, the trenches 108a may be formed through, for example, an imprinting process or a laser process. When the imprinting process is used, an imprint mold which has a configuration corresponding to that of the trenches 108a is pressed on the first insulating layer 103 to form the trenches 108a on the first insulating layer 103. In this case, the cost and time required to process the trenches may be reduced as compared to other processes. Meanwhile, when the laser process is used, the trenches 108a may be formed using an excimer laser.

In this embodiment, when it is necessary to further form vias 107b to connect a wiring circuit pattern 104b with the first circuit layer 102, via-holes 107a may be further formed along with the trenches 108a. In this case, the via-holes 107a may be formed to the upper surface of the first circuit layer 102 from the upper surface of the first insulating layer 103. Returning to the case in which the trenches 108a are formed through the imprint process, protrusions of the imprint mold may be partially extended to form the via-holes 107a. Alternatively, the via-holes 107a may be separately formed using CO₂ laser.

The wiring trenches 104a function to provide regions on which the wiring circuit pattern 104b is formed later, and the dummy trenches 106a function to provide regions on which dummy circuit patterns 106b are formed later.

Subsequently, as shown in FIG. 7, the trenches 108a and the via-holes 107a are internally plated.

At this point, the plating process may be performed in such a manner that an electroless plating layer is formed on the internal surfaces of the trenches 108a and the via-holes 107a and then an electrolytic plating layer is formed on the electroless plating layer. The plating layer may be embodied using the same electroconductive metal as the first circuit layer 102. In this plating process, as the via-holes 107a are internally plated, the vias 107b functioning to electrically connect the first circuit layer 102 with the wiring circuit pattern 104b are formed.

In this embodiment, since the design density of trenches 108a formed on the first insulating layer 103 is controlled by the formation of the dummy trenches 106a to be substantially even, deviation of the plating thickness can be reduced in the plating of the trenches 108a. More specifically, since the dummy trenches 106a are formed on regions on which the wiring trenches 104a are loosely distributed, deviation of the plating thickness of the trench plating layer 108b can be reduced.

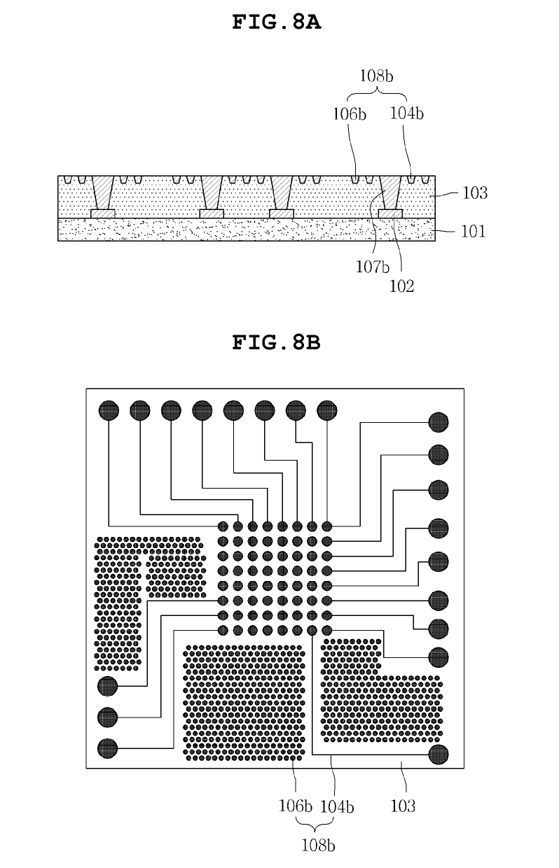

As shown in FIGS. 8A and 8B, an excessive plating layer 109 is removed from the plating layer 108b, 109.

At this point, the excessive plating layer 109 may be removed using a chemical or mechanical polishing process or a CMP process. As a result of removal of the excessive plating layer 109, the trench circuit layer 108b composed of the wiring circuit pattern 104b and the dummy circuit pattern 106b, which has a surface flush with the upper surface of the first insulating layer 103, may be formed. In this case, the trench circuit layer 108b has an engraved profile in which the trench layer 108b infiltrates into the first insulating layer 103.

In this embodiment, because the dummy circuit pattern 106b is not electrically connected to the wiring circuit pattern 104b, the dummy circuit pattern 106b is independent of the operation of the circuit.

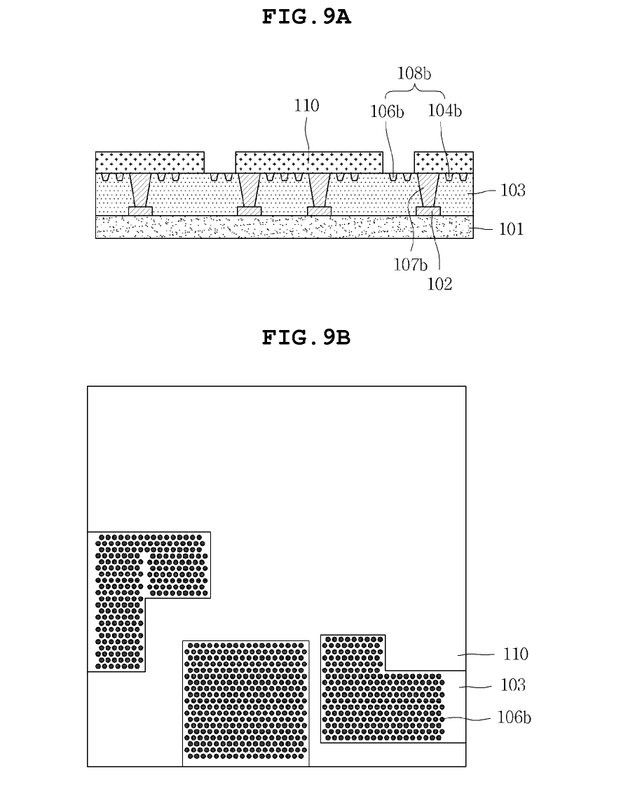

As shown in FIGS. 9A and 9B, an etching resist 110 is deposited on the first insulating layer 103 such that the dummy circuit pattern 106b of the trench circuit layer 108b is exposed through the etching resist 110.

At this point, the etching resist 110 functions to protect the wiring circuit pattern 104b from the etching solution, and may be composed of material such as liquid resist which is not removed by the etching solution.

In this embodiment, although the etching process is applied in order to remove the dummy circuit pattern 106b, it is provided for illustrative purpose. The present invention is not limited to the etching process, and any of processes known in the art may be used as long as it can remove the dummy circuit pattern 106b.

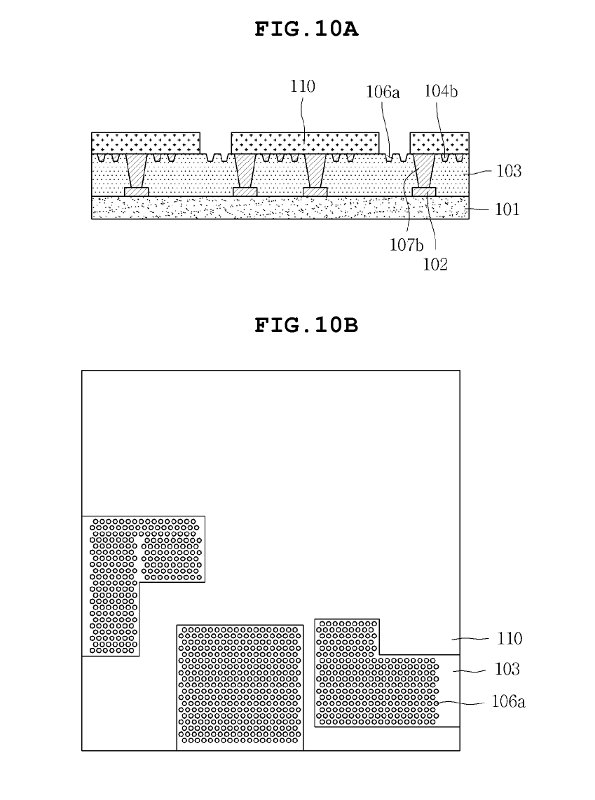

As shown in FIGS. 10A and 10B, the etching solution is applied on the areas of the first insulating layer 103 which were exposed by the etching resist 110, so as to remove the dummy circuit pattern 106b.

Consequently, the plating layer of the dummy circuit pattern 106b is removed by the etching solution, and thus the dummy trenches 106a again emerge. In this process, the etching solution may include, for example, iron chloride (FeCl₃) etchant, copper chloride (CuCl₂) etchant, alkaline etchant and the like.

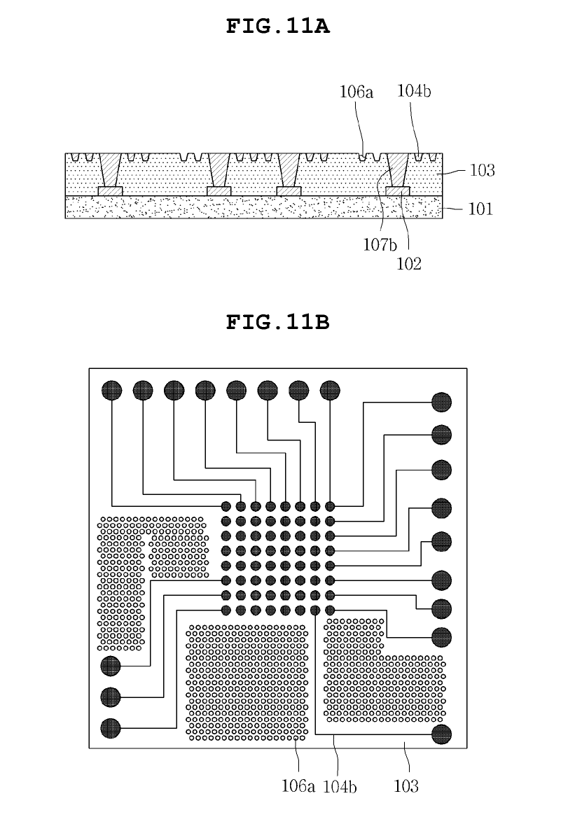

As shown in FIGS. 11A and 11B, the etching resist 110 is removed. As a result of removal of the etching resist 110, the wiring circuit pattern 104b is exposed to the outside along with the dummy trenches 106a.

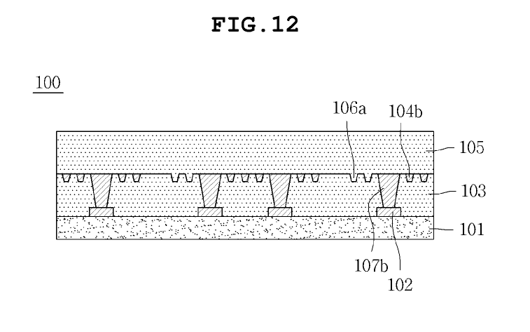

Next, as shown in FIG. 12, a second insulating layer 105 is deposited on the first insulating layer 103 on which is located the trench circuit layer 108b excluding the dummy circuit pattern 106b.

At this point, the dummy trenches 106a are filled with the second insulating layer 105 serving as an insulating material. As the second insulating layer 105 was cured in the dummy trenches 106a, the second insulating layer 105 may be integrated with the first insulating layer 103.

Consequently, the resulting printed circuit board 100 may be configured to be identical to a printed circuit board which is manufactured without forming the dummy trenches 106a.

The second insulating layer 105 may be composed of the same insulating material as the first insulating layer 103.

Although not shown in these drawings, a build-up layer, which is composed of a build-up circuit layer, vias for interlayer connection and a build-up insulating layer and which is prepared through a build-up process, may be further applied onto the second insulating layer 105.

In this case, the build-up circuit layer may be formed by the process of forming the trench circuit layer 108b or the first circuit layer 102. The build-up layer may be composed of a single layer or a plurality of layers.

Through the above-described process, the printed circuit board 100 according to this embodiment of the present invention is manufactured, as shown in FIG. 12.

As described above, the method of manufacturing a printed circuit board is such that the original design density in a region in which wiring trenches are densely distributed is maintained, and a blank region positioned between the trench regions is additionally provided with dummy trenches so that the trenches formed over the entire area have an even density. Consequently, the present invention has an advantage in that there is no deviation of plating thickness in a circuit layer.

Furthermore, even though the dummy trenches are additionally provided, the present invention advantageously realizes the design density of a printed circuit board by removing a plating layer in the dummy trenches and filling the dummy trenches with an insulating layer.

Although the embodiment of the present invention has been disclosed for illustrative purposes, the embodiment is provided to concretely describe the present invention rather than to limit the method of manufacturing a printed circuit board according to the present invention. Accordingly, those skilled in the art will appreciate that various modifications, additions and substitutions are possible, without departing from the scope and spirit of the invention as disclosed in the accompanying claims, and thus such modifications, additions and substitutions should also be understood as falling within the scope of the present invention.

What is claimed is:

1. A method of manufacturing a printed circuit board, comprising:
(A) forming a first circuit layer on a base substrate and forming a first insulating layer thereon;
(B) forming trenches including dummy trenches and wiring trenches on the first insulating layer and plating the trenches, thus providing a trench circuit layer including a dummy circuit pattern and a wiring circuit pattern;
(C) removing the dummy circuit pattern from the trench circuit layer; and
(D) forming a second insulating layer on the trench circuit layer from which the dummy circuit pattern was removed.

2. The method as set forth in claim 1, wherein (B) forming and plating the trenches comprises:
(B1) forming the trenches including the dummy trenches and the wiring trenches on the first insulating layer;
(B2) forming a plating layer in the trenches; and
(B3) polishing excessive plating of the plating layer, thus providing the trench circuit layer including the dummy circuit pattern and the wiring circuit pattern.

3. The method as set forth in claim 1, wherein, in (B) forming and plating the trenches, the trenches are formed through a laser process or an imprint process.

4. The method as set forth in claim 1, wherein (C) removing the dummy circuit pattern comprises:
(C1) forming etching resist on the trench circuit layer such that the dummy circuit pattern of the trench circuit layer is exposed by the etching resist;
(C2) applying an etching solution on the first insulating layer to etch and thus remove the dummy circuit pattern; and
(C3) removing the etching resist.

5. The method as set forth in claim 1, wherein, in (D) forming a second insulating layer, the dummy trenches from which the dummy circuit pattern were removed are filled with the second insulating layer.

6. The method as set forth in claim 1, wherein the dummy circuit pattern is not electrically connected to the wiring circuit pattern.

7. The method as set forth in claim 1, wherein the first circuit layer is electrically connected to the wiring circuit pattern of the trench circuit layer by a via.

8. The method as set forth in claim 1, further comprising:
(E) forming a build-up layer composed of a build-up circuit layer and a build-up insulating layer on the second insulating layer.
